(19) United States
(12) Patent Application Publication
(10) Pub. No.: US 2012/0203452 A1
(43) Pub. Date: Aug. 9, 2012

(54) METHOD FOR OPERATING A MOTOR VEHICLE AND MOTOR VEHICLE

(75) Inventor: Malte JACOBS, Ginsheim-Gustavsburg (DE)

(73) Assignee: GM GLOBAL TECHNOLOGY OPERATIONS LLC, Detroit, MI (US)

(21) Appl. No.: 13/364,459

(22) Filed: Feb. 2, 2012

(30) Foreign Application Priority Data
Feb. 4, 2011 (DE) 10 2011 010 377.5

(51) Int. Cl. G01C 21/34

(52) U.S. Cl. 701/411; 701/461; 701/430; 701/428

(57) ABSTRACT

A method is provided for operating a motor vehicle travelling on a roadway. The method has at least determining a position of the motor vehicle. In addition, a selection takes place of a dataset from map data deposited in a memory device such that the selected dataset contains the determined position of the motor vehicle. Furthermore, a determining takes place of a lane of the roadway travelled along by the motor vehicle by means of data determined from an optical camera of the motor vehicle. Moreover a selection takes place of the determined lane in the dataset as own lane of the motor vehicle.

### CROSS-REFERENCE TO RELATED APPLICATION

This application claims priority to German Patent Application No. 10 2011 010 377.5, filed Feb. 4, 2011, which is incorporated herein by reference in its entirety.

### TECHNICAL FIELD

The technical field relates to a method for operating a motor vehicle, a motor vehicle, a computer program product, and a computer-readable medium.

### BACKGROUND

From DE 103 44 120 A1 a method and a device are known for the representation of navigation instructions on a projection surface in a vehicle. The device comprises a navigation system that determines position information for the vehicle continuously by means of a satellite-supported system, and which by means of an image-generating unit generates the navigation instructions, determined from the navigation system, in an image of the environment of the vehicle. Reliability for the position information is determined and the image-generating unit generates the navigation instructions in differing representation dependent on reliability.

It is at least one object to provide a method for operating a motor vehicle, a motor vehicle, a computer program product, and a computer-readable medium, which enable an improved determining of a position of the motor vehicle. In addition, other objects, desirable features, and characteristics will become apparent from the subsequent summary and detailed description, and the appended claims, taken in conjunction with the accompanying drawings and this background.

### SUMMARY

According to an embodiment, a method for operating a motor vehicle traveling on a roadway has the following steps. A determining of a position of the motor vehicle takes place. In addition, a selection takes place of a dataset from map data deposited in a memory device such that the selected dataset contains the determined position of the motor vehicle. Furthermore, a determining takes place of a lane of the roadway traveled along by the vehicle by means of data determined from at least one optical camera of the motor vehicle. Moreover, a selection takes place of the determined lane in the data set as the vehicle's own lane.

The method for operating the motor vehicle according to this embodiment enables an improved determining of a position of the motor vehicle. This is made possible by the determining of a lane of the roadway travelled along by the motor vehicle by means of data of the at least one optical camera of the motor vehicle. The application proceeds here from the consideration that GPS-based position determining systems can determine the position of the motor vehicle only with a certain degree of accuracy, for example of approximately five meters. Therefore, through GPS-based systems, an allocation of the motor vehicle, which is accurate with regard to lane, cannot take place to the necessary degree. The method according to the embodiment, on the other hand, enables in an advantageous manner a lane-accurate positioning of the motor vehicle based on the data determined from the at least one optical camera. Thereby, the selecting of the determined lane in the data set can take place as the vehicle's own lane.

In an embodiment, the memory device is a component of a navigation system. Navigation systems already have memory devices with map data, whereby the number of components additionally required for the method can be advantageously reduced in the said embodiment. In a further embodiment, the determining of the position of the motor vehicle takes place by means of a position-determining device of the navigation system. The position determining device is typically constructed here as a satellite-supported system. This leads again to a reduction of the components additionally required for the method. The determining of the lane that is travelled along by the motor vehicle preferably contains a determining of boundary markings of the lane in images taken by the at least one optical camera. This enables a simple and reliable evaluation of the images taken by the at least one optical camera and thereby a reliable determining of the lane.

In a further embodiment, a routing is carried out by means of the navigation system. By means of data determined from the at least one optical camera, it is determined in the embodiment whether the motor vehicle is situated on a required lane for the routing. The camera-based determining again enables a lane-accurate positioning of the motor vehicle and hence a reliable checking as to whether the motor vehicle is situated on the required lane.

If it is determined that the motor vehicle is not situated in the required lane for the routing, preferably an announcement is issued. The announcement contains information for merging into the required lane. Thereby, the occupants of the motor vehicle, in particular the driver of the motor vehicle, can be alerted in an advantageous manner to a timely merging into the required lane. This is advantageous in particular in driving situations in which the further journey route is established by the choice of lane, for example, at expressway interchanges. There, lanes often run parallel but do not permit a change between the lanes. In such situations, navigation systems with only GPS-based position determining systems cannot clearly allocate the position of the motor vehicle, whereby an erroneous positioning could take place and thereby an incorrect route selection could be executed, or respectively the navigation system, after detecting the incorrect positioning, could fail for some time.

In addition, a further travel course of the motor vehicle based on the lane selected as the motor vehicle's own lane can be determined. Thereby, the further travel course of the motor vehicle can be determined to as accurate an extent as possible and hence a so-called electronic horizon, which is also designated as E-horizon or respectively ADAS horizon (ADAS: Advanced Driver Assistance System), can be provided for the motor vehicle, for example, via the so-called ADASIS protocol (ADASIS: Advanced Driver Assistance System Interface Specification).

The determined further travel course is preferably communicated to at least one driver assistance system. The at least one driver assistance system is selected from the group consisting of an adaptive cornering lamp, a shift point indicator and an intersection assistant. The systems can be designed in a distinctly improved manner or respectively activated in an optimum manner by the timely identification of the route. In the case of the shift point indicator, which is for example a component of an eco-system of the motor vehicle, the data can be used in order to enable a fuel-optimized shift operation, where fuel can be saved and exhaust gas emissions can be reduced. If the motor vehicle has an automatic transmission, the determined further travel course can be utilized in addition as an input parameter for an automatic shift operation.

Furthermore, the determined further travel course can be communicated additionally or alternatively to at least one further motor vehicle by means of a vehicle-to-vehicle communication device. Thereby, further road users can be informed of the travel course of the motor vehicle or respectively this travel course can be used as input quantity for driver assistance systems of the at least one further motor vehicle.

A motor vehicle is also provided that has a position-determining device that is constructed for determining a position of the motor vehicle. In addition, the motor vehicle has a memory device with map data. Furthermore, the motor vehicle has a first selector device that is constructed for selecting a dataset of the map data deposited in the memory device such that the selected dataset contains the determined position of the motor vehicle. Furthermore, the motor vehicle has at least one optical camera and a first determining device, which is constructed for determining a lane of a roadway which is travelled along by the motor vehicle, by means of data determined from the at least one optical camera. Furthermore, the motor vehicle has a second selector device that is constructed for selecting the determined lane in the dataset as the motor vehicle's own lane. The motor vehicle according to an embodiment has the advantages already mentioned in connection with the method, which are not set forth again at this point to avoid repetitions. In an embodiment, the position-determining device and/or the memory device are a component part of a navigation system.

In another embodiment, the motor vehicle has in addition a second determining device, which is constructed for determining a further travel course of the motor vehicle based on the lane that is selected as the motor vehicle's own lane. Moreover, the motor vehicle preferably has in addition at least one driver assistance system, selected from the group consisting of an adaptive cornering lamp, a shift point indicator and an intersection assistant, wherein the determined further travel course is communicated or is able to be communicated to the at least one driver assistance system. In the embodiments, the motor vehicle is, for example, an automobile or a truck.

Furthermore, a computer program product is provided which, when it is affected on a processing unit of a motor vehicle travelling on a roadway, instructs the processing unit to carry out the following steps. The processing unit is instructed to determine a position of the motor vehicle. In addition, the processing unit is instructed to select a dataset from map data deposited in the memory device, such that the selected dataset contains the determined position of the motor vehicle. Furthermore, the processing unit is instructed to determine a lane of the roadway that is travelled along by the motor vehicle, by means of data determined from at least one optical camera of the motor vehicle. In addition, the processing unit is instructed to select the determined lane in the dataset as the motor vehicle's own lane.

A computer-readable medium is provided on which a computer program product according to the embodiment is stored. The computer program product and the computer-readable medium have the advantages already mentioned in connection with the method, which are not set forth again at this point to avoid repetitions.

### BRIEF DESCRIPTION OF THE DRAWINGS

The present invention will hereinafter be described in conjunction with the following drawing figures, wherein like numerals denote like elements, and:

FIG. 1 shows a flow diagram of a method for operating a motor vehicle according to an embodiment;

FIG. 2A shows a flow diagram of a method for operating a motor vehicle according to another embodiment;

FIG. 2B shows a flow diagram of a method for operating a motor vehicle according to another embodiment;

FIG. 3 shows an example of a traffic situation in which the method according to the embodiment can be used; and

FIG. 4 shows a navigation system of the first motor vehicle shown in FIG. 3 according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

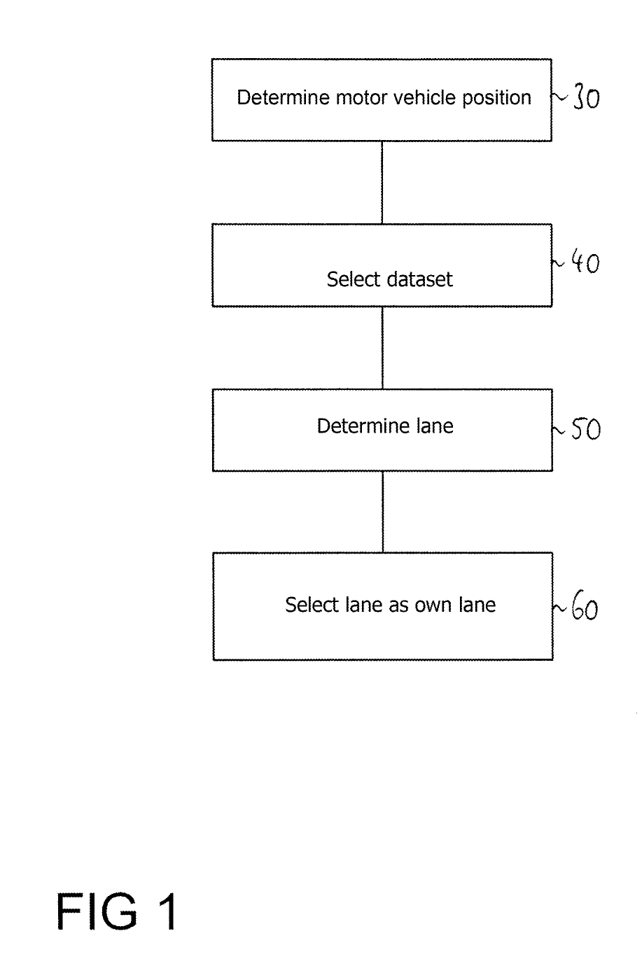

FIG. 1 shows a flow diagram of a method for operating a motor vehicle, travelling on a multilane roadway, according to an embodiment. The motor vehicle is, for example, an automobile or a truck. In a step 30, a determining takes place of a position of the motor vehicle. The determining of the position of the motor vehicle takes place here in the embodiment that is shown by means of a position determining device of a navigation system of the motor vehicle, i.e., by means of a satellite-supported system.

In a step 40 a selection takes place of a dataset from map data deposited in a memory device. The selection takes place here such that the selected dataset contains the determined position of the motor vehicle. The memory device in the embodiment, which is shown, is a component of the navigation system. By means of data determined from at least one optical camera of the motor vehicle, in a step 50 a lane of the multilane roadway travelled along by the motor vehicle is determined. The determining of the lane travelled along by the motor vehicle preferably contains a determining of boundary markings of the lane in images taken by the at least one optical camera. In a step 60 a selection takes place of the determined lane in the dataset as the motor vehicle's own lane. The method according to the embodiment that is shown enables a lane-accurate positioning of the motor vehicle and hence an improved determining of the position of the vehicle.

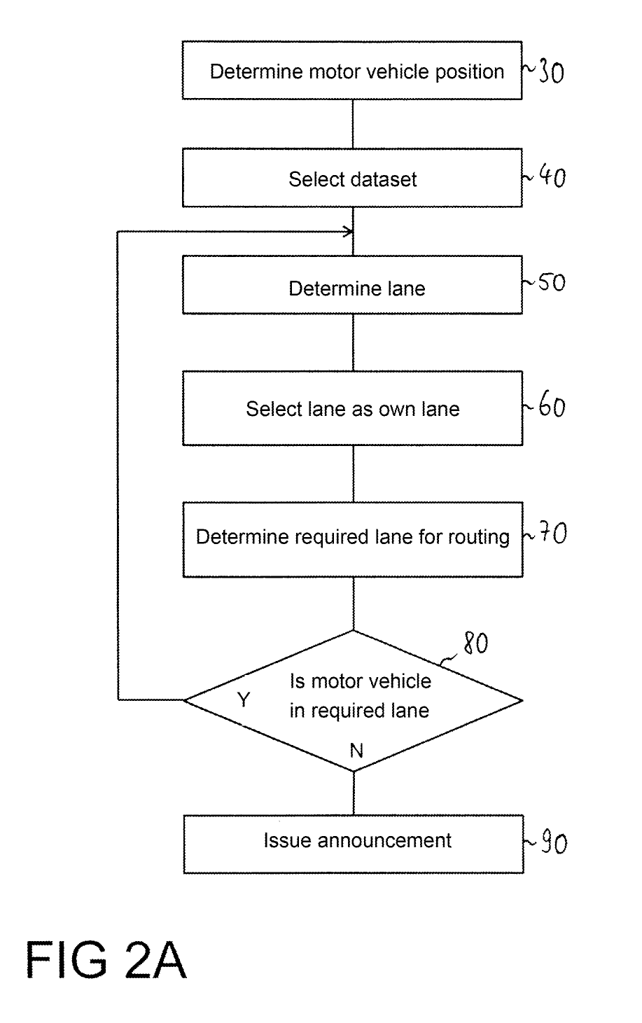

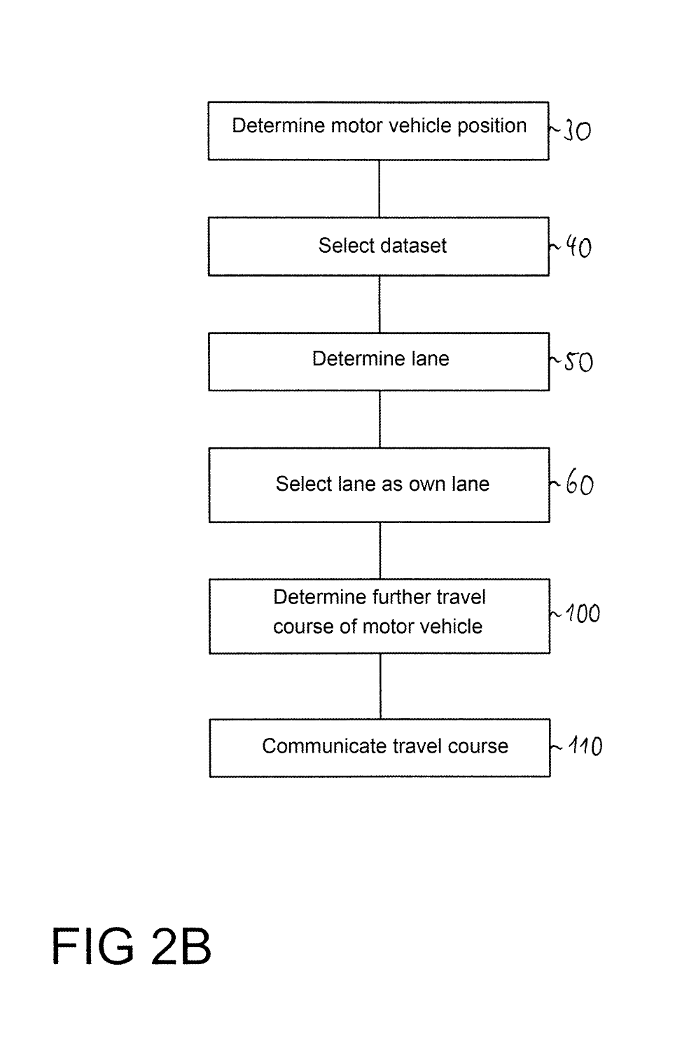

FIG. 2A shows a flow diagram of a method for operating a motor vehicle travelling on a multilane roadway according to another embodiment. The motor vehicle is, for example, again an automobile or a truck. In the embodiment which is shown, in a step 30 a determining takes place of a position of the motor vehicle, and in a step 40 a selection takes place of a dataset from map data deposited in a memory device, such that the selected dataset contains the determined position of the motor vehicle, in accordance with the steps 30 and 40 of the first embodiment shown in FIG. 1.

In addition, in a step 50 a determining takes place of a lane of the multilane roadway travelled along by the motor vehicle, by means of data determined from at least one optical camera of the motor vehicle, and in a step 60 a selection takes place of the determined lane in the dataset as the motor vehicle's own lane, in accordance with steps 50 and 60 of the first embodiment shown in FIG. 1. Furthermore, in this embodiment of the method, in a step 70 a determining takes place of a required lane for a routing, i.e., a routing is carried out by means of the navigation system and a target lane is determined for the motor vehicle. The lane positioning by the camera data is thereby carried out in the embodiment, which is shown still before the actual navigation. The route guidance can be carried out in the motor vehicle itself or else externally, for example, via satellite.

In a step 80 it is determined, by means of data determined from the at least one optical camera, whether the motor vehicle is situated in the required lane for the routing. The data determined in step 50 can serve for this, i.e., the required lane is compared with the lane, which is determined as the motor vehicle's own lane. Furthermore, the optical camera can gather data repeatedly or respectively continuously and the lane, which is travelled along by the motor vehicle, can be determined therefrom and compared with the required lane.

If it is determined in step 80 that the motor vehicle is situated in the required lane for the routing, steps 50, 60, 70 and 80 are carried out repeatedly. If, on the other hand, it is determined in step 80 that the motor vehicle is not situated in the correct lane for the routing, an announcement is issued in a step 90. The announcement contains information for merging into the required lane. Thereby, the occupants of the motor vehicle, in particular the driver of the motor vehicle, can receive instructions for the timely merging into the correct lane and the complying with this instruction can be monitored or controlled. The announcement can be issued here as an acoustic and/or optical announcement.

FIG. 2B shows a flow diagram of a method for operating a motor vehicle travelling on a multilane roadway according to another embodiment. The motor vehicle is, for example, an automobile or a truck. In this embodiment which is shown, in a step 30 a position of the motor vehicle is determined and in a step 40 a dataset is selected from map data deposited in a memory device such that the selected dataset contains the determined position of the motor vehicle. The steps 30 and 40 are carried out in accordance with the steps 30 and 40 of the embodiment shown in FIG. 1.

In addition, in a step 50, a determining takes place of a lane of the roadway that is travelled along by the motor vehicle by means of data determined from at least one optical camera of the motor vehicle, and in a step 60 a selection takes place of the determined lane in the dataset as the motor vehicle's own lane, in accordance with the steps 50 and 60 of the first embodiment shown in FIG. 1.

Furthermore, in this third embodiment of the method, which is shown, in a step 100, a further travel course of the motor vehicle is determined, based on the lane, which is selected as the motor vehicle's own lane. Thereby, an electronic horizon, which is also designated as ADAS horizon and forms an interface between the navigation system of the motor vehicle and at least one further driver assistance system, is provided for the motor vehicle.

In a step 110 the determined further travel course is communicated to the at least one driver assistance system. Thereby the further travel course is available to the driver assistance system as an input quantity. The path-based driver assistance system is selected here from the group consisting of an adaptive cornering lamp, which is also designated as AFL (Adaptive Forward Lighting or respectively Adaptive Front Lighting System), a shift point indicator, and an intersection assistant. The shift point indicator can be a component of a so-called eco system, which uses the ADAS horizon for the fuel-optimized shift operation. The eco system is also designated here as eco drive. If the motor vehicle has an automatic transmission, the determined further travel course can be utilized in addition as an input parameter for an automatic shift operation. In addition, the determined further travel course in the embodiment, which is shown, is communicated in the step 110 to at least one further motor vehicle by means of a vehicle-to-vehicle communication device. Furthermore, a combination of the embodiments shown in FIG. 2A and FIG. 2B is possible.

The embodiments, which are shown, proceed here from the consideration that digital map data increasingly contain further applications, in particular in the automobile field. In addition to the pure navigation data, increasingly also further attributes, for example bends, incline data and traffic signs, are deposited on the maps, in order to be made available for driver assistance functions. The relevant data, after establishing of the vehicle position, for example via GPS data, are passed on to the vehicle applications.

For particular applications, it is advantageous here to obtain a lane-accurate positioning, in particular if the further travel route is established through the lane selection, as can be the case, for example, at expressway intersections. There, lanes often run parallel, but partly do not permit a change between the lanes. Navigation systems, which only determine the position of the motor vehicle in a satellite-supported manner, often do not position in a lane-accurate manner in such situations, so that frequently an erroneous positioning takes place and thereby an incorrect route selection is executed. Furthermore, after recognizing an incorrect positioning, the navigation typically fails for some time.

The embodiments, which are shown, make it possible to improve the positioning of the vehicle on the digital map through camera data. This lane-accurate allocation not only allows the temporary incorrect state or respectively the failure of the navigation system to be avoided, but rather also optimizes the use of the ADAS horizon for driver assistance systems which use map data as input values. The positioning on the digital map can take place in a lane-accurate manner by the additional use of camera data in accordance with the embodiments that are shown. Cameras that can provide this lane information from video data are being installed to an increased extent in vehicles.

Through the camera, the current lane on the roadway is preferably followed continuously. By reproducing the current position on the digital map, the system detects, for example, the reaching of an intersection situation, at which the choice of the lane determines at the same time the further travel route. In the embodiments that are shown, the choice of the lane is returned directly to the navigation- and positioning system. Through the integration of the lane, the navigation already receives information in advance concerning the further travel path of the vehicle.

In addition, several applications can benefit from the lane-accurate calculation, for example route guidance, light control, and eco-drive. The individual applications do not require their own camera system here, or respectively do not require their own access to the camera data. Furthermore, the route guidance is carried out directly using the camera data, i.e. the lane data. Thereby, incorrect route guidance can already be corrected at the choice of lane. In addition, the correct route guidance can also be supplied to the downstream applications directly after the lane choice, where these can react more immediately and, for example the transmission of further characteristics, such as for example bends in the road for light controls, can be carried out more quickly.

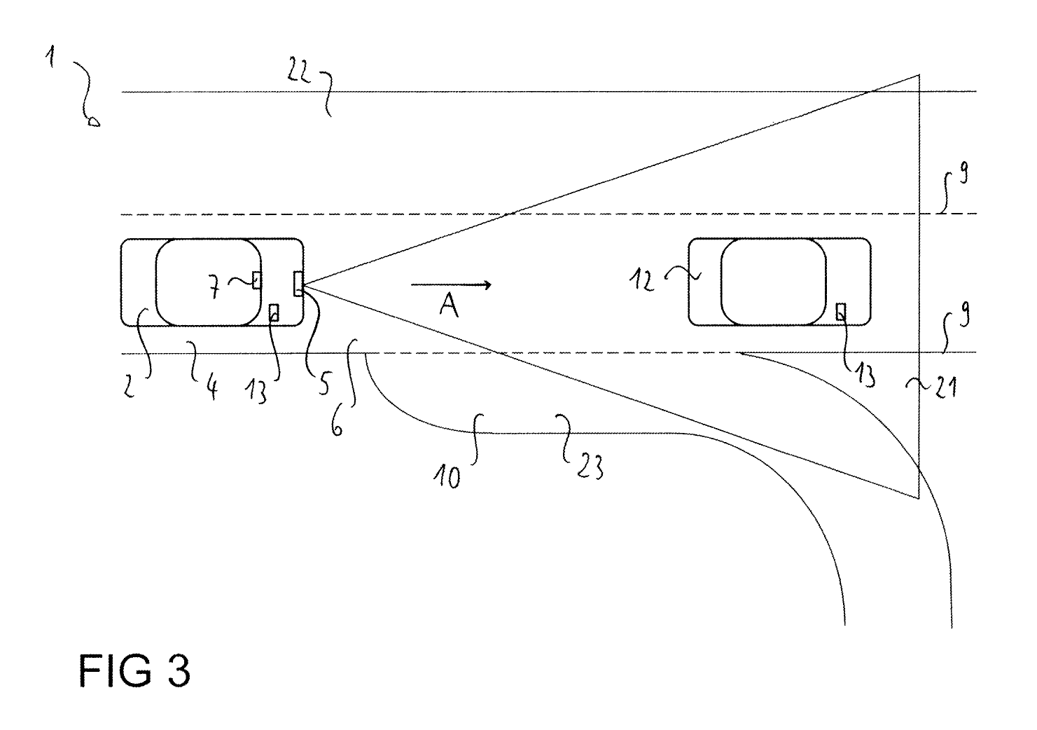

FIG. 3 shows an example of a traffic situation in which the method according to the embodiments, in particular a method according to the embodiments shown in FIG. 1, FIG. 2A, and FIG. 2B, can be used. In the illustrated traffic situation, a first motor vehicle 2, which is an automobile in the embodiment, which is shown, travels in a travel direction illustrated diagrammatically by means of an arrow A in a first lane 4 of a roadway 1. The roadway 1 has, in addition to the first lane 4, a further lane 22 in the travel direction of the first motor vehicle 2 and is, for example, a highway or an expressway. In addition, the roadway 1 adjacent to the first lane 4 has a lane 23, which forms an exit. In the travel direction of the first motor vehicle 2, a second motor vehicle 12 is travelling in front of it in the first lane 4.

The first motor vehicle 2 has a navigation system 7 and an optical camera 5. The optical camera 5 has here a schematically illustrated detection range 21. By means of data determined from the optical camera 5 of the first motor vehicle 2, the lane 4, which is travelled along here by the first motor vehicle 2, can be determined. The determining of the lane 4 travelled along by the first motor vehicle 2 contains, in the situation that is shown, a determining of boundary markings 9 of the lane 4 in images taken by the optical camera 5.

As explained in further detail in connection with the following figure, the determined lane 4 can be selected as the own lane 6 of the first motor vehicle 2 in a dataset which contains map data. Based on the lane selected as the motor vehicle's own lane, a further travel course of the motor vehicle is determined and is communicated to a driver assistance system of the first motor vehicle 2. In addition, the determined further travel course can be communicated to the second motor vehicle 12 by means of a vehicle-to-vehicle communication device 13.

Furthermore, by means of data determined from the optical camera 5, it is determined whether the first motor vehicle 2 is situated in a required lane 10 for a routing, which is carried out by means of the navigation system 7. In the traffic situation, which is shown, the required lane 10 is formed here by the lane 23. As already explained, the first motor vehicle 2 is situated in the lane 4 and hence not in the required lane 10 for the routing. As is likewise explained in further detail in connection with the following figure, therefore an issuing of an announcement takes place inside the first motor vehicle 2, wherein the announcement contains information for merging into the required lane 10.

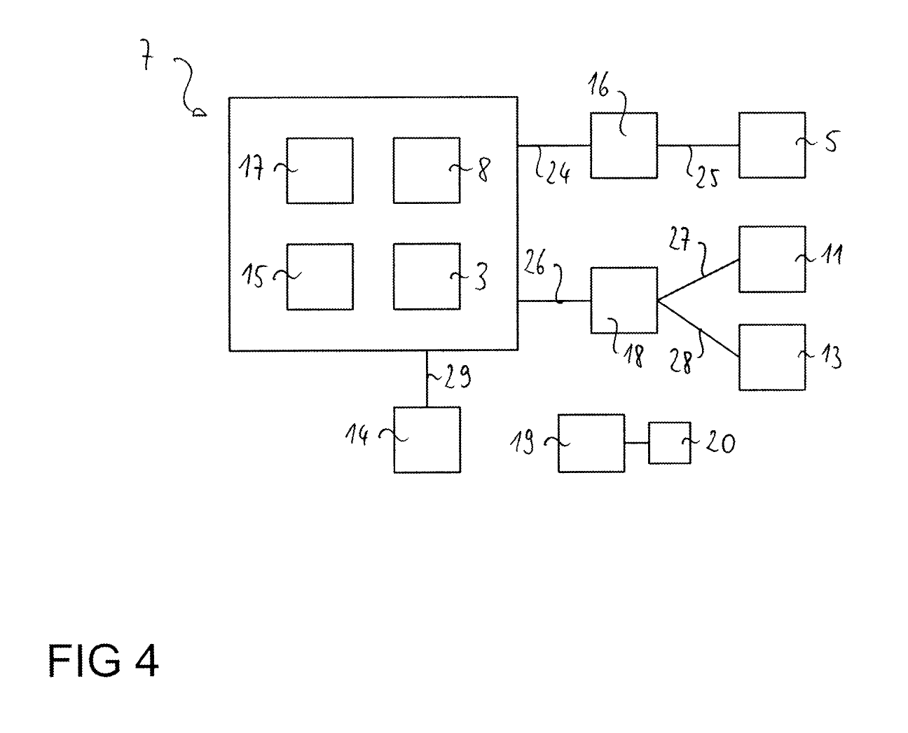

FIG. 4 shows for this the navigation system 7 of the first motor vehicle, shown in FIG. 3, according to an embodiment. Components having the same functions as in FIG. 3 are characterized by the same reference numbers and are not explained again below. In the embodiment which is shown, the navigation system 7 has a position determining device 8 that is constructed for the satellite-supported determining of a position of the first motor vehicle, for example by means of GPS data. In addition, the navigation system 7 has a memory device 3 with digital map data deposited therein. Furthermore, the navigation system 7 has a first selector device 15, which is constructed for selecting a dataset of the map data deposited in the memory device 3 such that the selected dataset contains the determined position of the first motor vehicle.

The first motor vehicle, which is not illustrated in further detail in FIG. 4, has in addition a first determining device 16, which is constructed for determining a lane of a roadway travelled along by the first motor vehicle, by means of data determined from the optical camera 5. The first determining device 16 is connected for this to the optical camera 5 via a signal line 25. Furthermore, the first determining device 16 is connected via a signal line 24 with the navigation system 7. The latter has, in addition, a second selector device 17 that is constructed for selecting the determined lane in the dataset as the first motor vehicle's own lane.

Furthermore, in the embodiment, which is shown, the first motor vehicle has at least one further sensor 14, which is connected via a signal line 29 with the navigation system 7. The sensor 14 is constructed for example as a steering angle sensor or as a yaw rate sensor, where further vehicle data is available to the navigation system 7 as input quantities for the route guidance. Furthermore, in the embodiment which is shown, the first motor vehicle has a second determining device 18, which is also designated as ADAS horizon and which is constructed for determining a further travel course of the first motor vehicle based on the lane which is selected as the first vehicle's own lane. The second determining device 18 is connected for this via a signal line 26 with the navigation system 7.

In addition, the first motor vehicle has a vehicle assistance system 11, selected from the group consisting of an adaptive cornering lamp, a shift point indicator, and an intersection assistant. The drive assistance system 11 is connected via a signal line 27 with the second determining device 18, whereby the determined further travel course can be communicated to the driver assistance system 11. Furthermore, the determined further travel course in the embodiment that is shown can be communicated to further road users by means of the vehicle-to-vehicle communication device 13. The vehicle-to-vehicle communication device 13 is connected here to the second determining device 18 via a signal line 28.

In addition, the first motor vehicle in the embodiment that is shown has a processing unit 19 and a computer-readable medium 20, where a computer program product is stored on the computer-readable medium 20, which, when it is effected on the processing unit 19, instructs the processing unit 19 to carry out the steps named in connection with the embodiments of the method, in particular the steps according to the embodiments shown in FIG. 1, FIG. 2A, and FIG. 2B, by means of the elements named there. For this, the processing unit 19 is connected, in a manner, which is not illustrated in further detail, directly or indirectly with the corresponding elements.

Although at least one example embodiment has been shown in the preceding description, various alterations and modifications can be carried out. The embodiments are merely examples and are not provided for limiting the extent of validity, the applicability, or the configuration in any way. Rather, the preceding description makes available to plan for the implementation at least of an example embodiment, where numerous alterations can be made in the function and in the arrangement of elements described in an example embodiment, without departing from the scope of protection of the attached claims and their legal equivalents.

What is claimed is:

1. A method for operating a motor vehicle that is traveling on a roadway, comprising:
determining a position of the motor vehicle;
selecting a dataset from map data stored in a memory device, the dataset containing the position of the motor vehicle;
determining a lane of the roadway traveled along by the motor vehicle with data determined from an optical camera of the motor vehicle; and
selecting the lane in the dataset as an own lane of the motor vehicle.

2. The method according to claim 1, wherein the memory device is a component of a navigation system.

3. The method according to claim 2, wherein the determining the position of the motor vehicle comprising determining the position of the motor vehicle with a position determining device of the navigation system.

4. The method according to claim 2, wherein the determining the lane traveled along by the motor vehicle comprising determine boundary markings of the lane.

5. The method according to claim 4, further comprising:
carrying out a routing is carried with the navigation system; and
determining with data from the optical camera whether the motor vehicle is situated in a required lane for the routing.

6. The method according to claim 5, further comprising announcing information for merging into the required lane if the motor vehicle is not situated in the required lane for the routing.

7. The method according to claim 1, further comprising determining a further travel course of the motor vehicle based on the lane that is selected as the own lane of the motor vehicle.

8. The method according to claim 7, further comprising communicating a travel course to a driver assistance system.

9. The method according to claim 8, wherein the driver assistance system is an adaptive cornering lamp.

10. The method according to claim 7, further comprising communicating the further travel course to a further motor vehicle with a vehicle-to-vehicle communication device.

11. A motor vehicle having
a position-determining device configured to determine a position of the motor vehicle;
a memory device configured to map data comprising a dataset;
a first selector device configured to select the dataset of the map data stored in the memory device that contains the position of the motor vehicle;
an optical camera configured to generate data;
a first determining device configured to determine a lane of a roadway travelled along by the motor vehicle with data determined from the optical camera;
a second selector device configured to select the lane in the dataset as an own lane of the motor vehicle.

12. The motor vehicle according to claim 11, wherein the position-determining device is a component of a navigation system.

13. The motor vehicle according to claim 11, further comprising a second determining device configured to determine a further travel course of the motor vehicle based on the lane selected as the own lane of the motor vehicle.

14. The motor vehicle according to claim 13, further comprising a driver assistance system that is configured to receive the further travel course.

15. A computer readable medium embodying a computer program product, said computer program product comprising:
an operating program for operating a motor vehicle that is traveling on a roadway, the operating program configured to:
determine a position of the motor vehicle;
select a dataset from map data stored in a memory device, the dataset containing the position of the motor vehicle;
determine a lane of the roadway traveled along by the motor vehicle with data determined from an optical camera of the motor vehicle; and
select the lane in the dataset as an own lane of the motor vehicle.

16. The computer readable medium embodying the computer program product according to claim 15, wherein the operating program is configured to determine the position of the motor vehicle with a position-determining device of a navigation system.

17. The computer readable medium embodying the computer program product according to claim 15, wherein the operating program is configured to determine boundary markings of the lane.

18. The computer readable medium embodying the computer program product according to claim 16, the operating program further configured to:
carry out a routing is carried with the navigation system; and
determine with data determined from the optical camera whether the motor vehicle is situated in a required lane for the routing.

19. The computer readable medium embodying the computer program product according to claim 18, the operating program is further configured to announce information for merging into the required lane if the motor vehicle is not situated in the required lane for the routing.

20. The computer readable medium embodying the computer program product according to claim 15, the operating program further configured to determine a further travel course of the motor vehicle based on the lane that is selected as the own lane of the motor vehicle.
